(19) United States
(12) Patent Application Publication
(10) Pub. No.: US 2009/0307427 A1
(43) Pub. Date: Dec. 10, 2009

(54) MEMORY CARD AND METHOD OF WRITING DATA

(75) Inventors: Satoru Takasuka, Tachikawa (JP); Kenzo Matsumura, Kitamoto (JP); Nobuyoshi Furihata, Akishima (JP); Yuichiro Onuki, Tokyo (JP); Hideyuki Kainuma, Tachikawa (JP)

Correspondence Address: MILES & STOCKBRIDGE PC, 1751 PINNACLE DRIVE, SUITE 500, MCLEAN, VA, 22102-3833, US

(73) Assignee: HITACHI ULSI Systems Co., Ltd.

(21) Appl. No.: 12/280,011

(22) PCT Filed: Mar. 31, 2006
(86) PCT No.: PCT/JP2006/306871

§ 371 Date: Feb. 24, 2009

(51) Int. Cl. G06F 12/00; G06F 12/16

(52) U.S. Cl. 711/115; 711/162; 711/E12.001; 711/E12.008

(57) ABSTRACT

When data is written into a memory card 1, if a write command and data are transferred from a host device 2, a memory controller 4 writes the data into an erased optional block. When the write operation is finished, the host device 2 transfers a second write command and data. The memory controller 4 judges whether a last address of the first transferred data and a head address of transfer data set by the second write command are continuous or not; and continuously writes, when the addresses are continuous, the second transfer data subsequently to the first data. And, when the data write operation is finished, a copy processing is carried out.

### TECHNICAL FIELD

The present invention relates to a technique of writing data into a memory card, in particular, to a technique effective for shortening a time of writing the data into the memory card using a nonvolatile semiconductor memory.

### BACKGROUND ART

As storage devices such as personal computers or DSCs (Digital Still Cameras), for example, there are widely used memory cards such as SD (Secure Digital) cards (registered trademark) and CF (Compact Flash) cards (registered trademark).

Along with recent requirement for high performance, as semiconductor memories mounted on the memory cards, for example, there are used nonvolatile semiconductor memories such as flash memories that can electrically erase and rewrite the data collectively and hold large volumes of data.

Generally, when the data is written into the memory card, a host such as a personal computer or DSC sets beforehand a volume of data transferred and a transfer address of the transfer data just before it issues a write command. And, after having issued the write command to the memory card, the set volume of data is transferred.

A memory controller provided in the memory card takes, as one unity, the write command and a data transfer subsequently to the same, and performs, to the nonvolatile semiconductor memory, a write operation of the volume of data according to contents of the set command.

In addition, in the nonvolatile semiconductor memory, the data is managed by a block unit decided at certain size (an erase unit at which a plurality of nonvolatile memory cells connected to a word line can be erased collectively).

In the nonvolatile semiconductor memory of this kind, for example, there is a technique (see Patent Document 1) in which: when a write instruction of a page unit occurs continuously plural times regarding pages of address order in the same block, the write operation is performed in the page unit in the same block; and then the write operation of the block is finished, whereby a write processing speed is made high.

Patent Document 1: Japanese Patent Application Laid-Open Publication No. 2004-264912

### DISCLOSURE OF THE INVENTION

### Problems to be Solved by the Invention

However, it has been found by the present inventors that, in the above-mentioned data writing technique of the memory card, there are the following problems.

When the host writes large volumes of data into the memory card, the data is divided into data sizes set by the host and the data transfer is repeated with the write command.

For example, when the data transfer is divided into two, the write command and the data of the divided first half are transferred to the memory card. The nonvolatile semiconductor memory used for the memory card overwrites and cannot update the data.

Therefore, after the data of the first half is written into the erased first block, the remaining original data except the data of the first half in the block to be a write object is copied.

When a copy processing is finished, the host transfers the write command and the data of the divided second half to the memory card. In response to this, the memory card writes the data of the second half into the other erased second block, and then copies the remaining data except the data of the second half in the first block.

Thus, in the memory card, the copy processings occur in proportion to the number of times of issue of the write command. There is the problem that while the memory card performs the copy processing, the host gets in a waiting state for the copy processing and cannot perform the data write processing, which results in an increase of the data write time.

In particular, when the data size divided while the host transfers the data is small, the number of times of issue of the write command extremely increases and there is a worry that the data write time increases significantly.

An object of the present invention is to provide, in a data write processing, a technique for significantly reducing the number of times of copy and thereby being capable of reducing significantly a data write time.

The above and other objects and novel features of the present invention will become apparent from the description of the present specification and the accompanying drawings.

### Means for Solving the Problems

Outlines of representative ones of the inventions disclosed in the present application will be briefly described as follows.

The present invention is a memory card comprising: a nonvolatile semiconductor memory having a plurality of nonvolatile memory cells and being capable of storing predetermined information therein; and a memory controller instructing an operation of the nonvolatile semiconductor memory based upon a command issued externally, wherein the memory controller judges, in a write processing of data arbitrarily divided by a host device, whether a last address of a previous data transfer and a head address of a next data transfer are continuous; and performs, if the addresses are continuous, no copy processing and the write processing of the data in the next data transfer subsequently to the data that has been written and processed in the previous data transfer.

Also, the present invention is an invention in which the memory controller performs the copy processing when the last address of the previous data transfer and the head addresses of the next data transfer are not continuous.

Further, the present invention is an invention in which the memory controller performs the copy processing after the write processing of the data is finished when a command other than a write command is issued from the host device.

Also, the present invention is an invention in which the memory controller performs the copy processing when the write processing of the data is finished after a period of time lapses from issue of a write command by the host device.

In addition, outlines of the other inventions in the present application will be brief described.

The present invention is a method of writing data in a memory card, the memory card comprising a nonvolatile semiconductor memory having a plurality of nonvolatile memory cells and being capable of storing predetermined information therein, and a memory controller instructing an operation of the nonvolatile semiconductor memory based upon a command issued externally, wherein the memory controller performs, when a last address of a previous data transfer that has been transferred from a host device and a head address of a next data transfer are continuous, no copy processing and the write processing of the data in the next data transfer subsequently to the data that has been written and performed in the previous data transfer.

Also, the present invention is an invention in which the copy processing is carried out when the last address of the previous data transfer and the head address of the next data transfer are not continuous and after the write processing of the data is finished when a command other than a write command is issued from the host device.

Further, the present invention is an invention in which the copy processing is carried out after the write processing of the data is finished when a period of time lapses from issue of the write command by the host device.

### EFFECT OF THE INVENTION

Effects obtained by representative ones of the inventions disclosed in the present application will be briefly described as follows.

(1) It is possible to reduce significantly the data write time in the memory card.

(2) Also, by above-mentioned item (1), the performance of the memory card can be improved.

### BRIEF DESCRIPTION OF THE DRAWINGS

FIG. 1 is a block diagram showing a configuration of a memory card according to an embodiment of the present invention;

FIG. 2 is an explanatory diagram showing a sequence of a host device when data is written into the memory card shown in FIG. 1;

FIG. 3 is a flowchart showings an operation when the data is written into the memory card shown in FIG. 1;

FIG. 4 is an explanatory diagram of an operational sequence showing one example of data write in the memory card shown in FIG. 1;

FIG. 5 is an explanatory diagram of an operational sequence showing one example when a read command is issued from the host device after the data write is performed to the memory card shown in FIG. 1;

FIG. 6 is an explanatory diagram of an operational sequence showing one example when no response is issued from the host device after the data write is performed to the memory card shown in FIG. 1;

FIG. 7 is an explanatory diagram of an operational sequence showing an example of a data write operation of a memory card in which a copy processing is performed per data write by a write command considered by the present inventors; and

FIG. 8 is a block diagram showing a configuration of a memory card according to another embodiment of the present invention.

### BEST MODE FOR CARRYING OUT THE INVENTION

Hereinafter, embodiments of the present invention will be described in detail based upon the drawings. Incidentally, throughout all the drawings for describing the embodiments, the same members are denoted in principle by the same reference numerals, and repetitive descriptions thereof will be omitted.

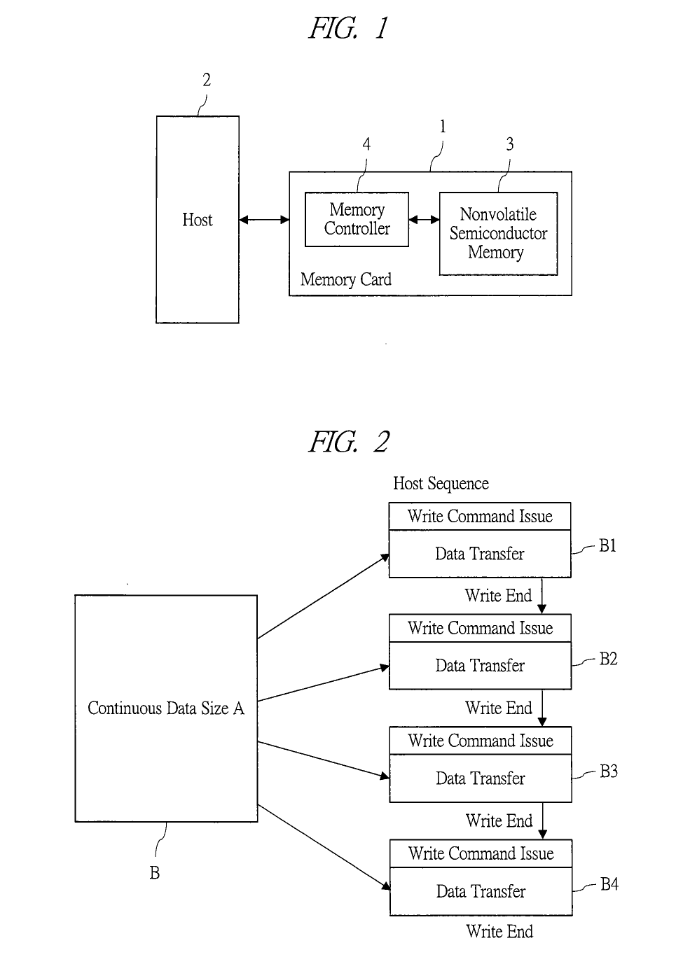

In the present embodiment, as shown in FIG. 1, a memory card 1 is intended so that a host device 2 can be connected to an outside of the memory card 1, and, for example, the memory card 1 is used as an external memory medium of the host device 2 such as a digital camera, a mobile telephone, a portable music player or a personal computer.

The memory card 1 is composed of: a nonvolatile semiconductor memory 3 that can electrically rewrite and erase data as exemplified by a flash memory; and a memory controller 4. The memory controller 4 is connected to the host device 2, controls the nonvolatile semiconductor memory 3, and reads out programs, data, and the like stored in the nonvolatile semiconductor memory 3 to output them to the host device 2 or instructs write operations of the programs and data inputted from the host device 2.

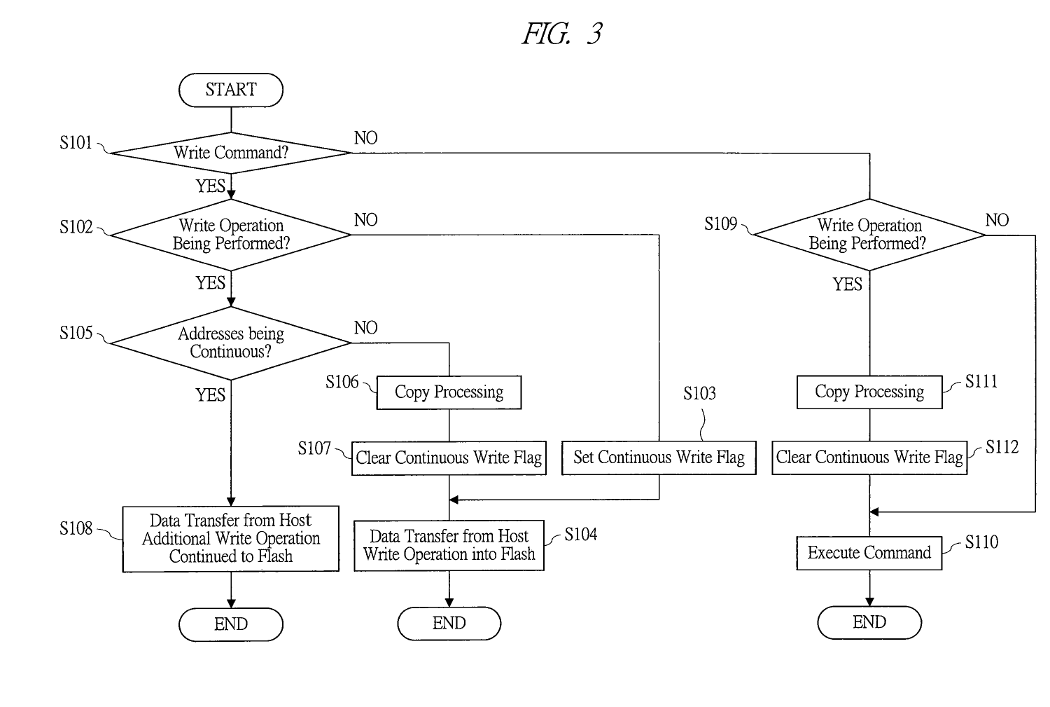

Next, the data write operation into the memory card 1 according to the present embodiment will be described with reference to FIG. 2.

FIG. 2 is an explanatory diagram showing a sequence of the host device 2 when a certain volume of data (data size “A”) is written into the memory card 1. FIG. 2 shows an example of a case where data “B” of the data size A is divided into data “B1” to “B4” and is transferred.

First, the host device 2 issues a first write command and transfers, to the memory card 1, the first write command and the data B1 obtained by arbitrarily dividing the data size A, respectively.

The memory controller 4 writes the data B1 into an erased arbitrary block. Herein, a copy processing which copies original data in a block to be a write object is not carried out. When the write operation of the data B1 into the memory card 1 is finished, the host device 2 transfers a second write command and the data B2 obtained by arbitrarily dividing the data size A, respectively.

The memory controller 4 judges whether a last address of the data B1 and a head address of transfer data set by the second write command are continuous or not; and writes, when the addresses are continuous, the data B2 subsequently to the data B1 into the erased block.

Also in this case, without performing the copy processing which copies the original data in the block to be a write object, the write operation (continuous write operation) of the transferred data B2 is carried out.

Thereafter, the host device 2 transfers a third write command and the data B3 obtained by arbitrarily dividing the data size A. In the same manner, the memory controller 4 judges whether a last address of the data B2 and a head address of the data transfer set by the third write command are continuous or not, and carries out, when the addresses are continuous, a continuous write operation of the data B3 transferred without performing the copy processing.

Subsequently, when the write operation of the data B3 in the memory card 1 is finished, the host device 2 transfers a fourth write command and the data B4 obtained by arbitrarily dividing the data size A, respectively.

The memory controller 4 judges whether a last address of the data B3 and a head address of data transfer set by the fourth write command are continuous or not. If the addresses are continuous, also in this case the memory controller 4 carries out a continuous write operation of the data B4 transferred subsequently to the data B3 without performing the copy processing. And, after the write operation of the data B4 is finished, the copy processing is performed.

Thus, even when the data of the data size A is divided into the data B1 to B4 and is transferred, since the copy processing of the memory card 1 can be performed only once, it is possible to significantly reduce a time required for the write operation.

FIG. 3 is a flowchart of the memory card 1 when a certain volume of data is written.

First, when a write command is issued from the host device 2, the memory controller 4 judges whether the command is a write command or not (step S101). When it is a write command, the memory controller 4 judges whether the continuous write operation of the data (FIG. 2) is being performed or not (step S102).

When the continuous write operation of data is not being performed, the memory controller 4 sets a continuous write flag (step S103), receives the data transfer from the host device 2, and writes the received data into the nonvolatile semiconductor memory 3 (step S104).

Further, in a processing of step S102, when the continuous write operation of data is being performed, the memory controller 4 judges whether the last address of the previous data transfer and the head address of the transfer data set by the present write command are continuous or not (step S105).

When the addresses are not continuous, the memory controller 4 performs the copy processing (step S106). Subsequently, when the copy processing is finished, the memory controller 4 clears the continuous write flag (step S107) and then performs a processing of step S104.

When the addresses are continuous in a processing of step S105, the memory controller 4 receives the data transfer from the host device 2 and performs continuously an addition write operation to the nonvolatile semiconductor memory 3 (step S108).

Further, in the processing of step S101, when the command issued from the host device 2 is not a write command, the memory controller 4 judges whether the continuous write operation of the data is being performed or not (step S109). When the continuous write operation of the data is not being performed, the memory controller carries out the command issued from the host device 2 (step S110).

Furthermore, in a processing of step S109, when the continuous write operation of data is being performed, the memory controller 4 carries out the copy processing (step S111), clears the continuous write flag when the copy processing is finished (step S112), and carries out a processing of step S110.

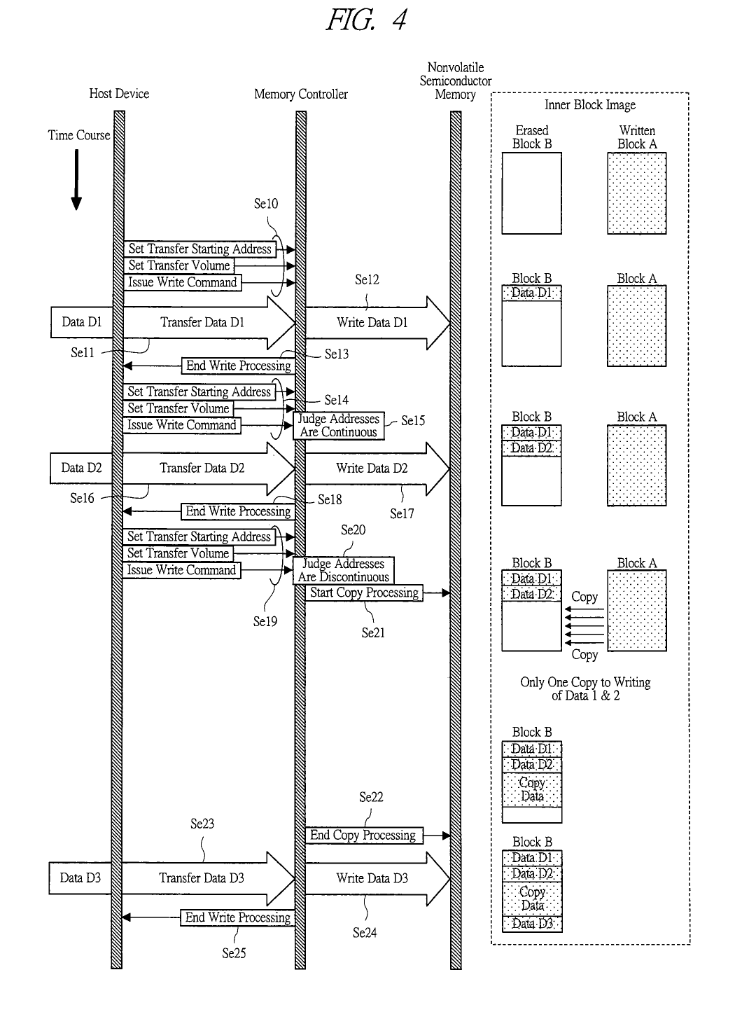

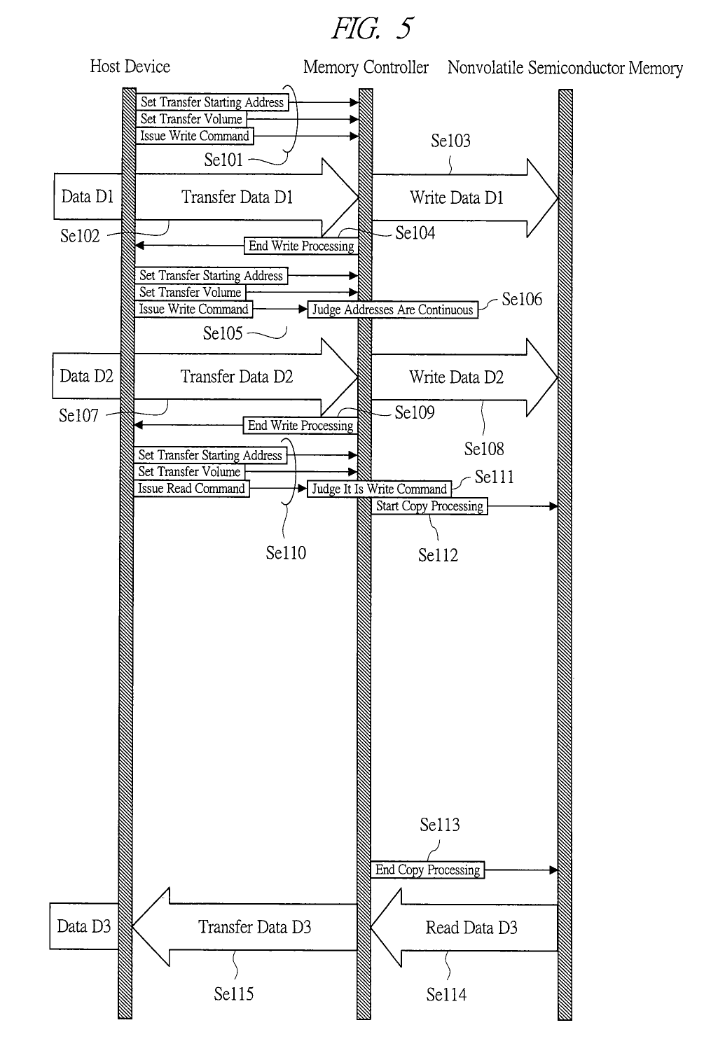

Next, data write operations in the memory card 1 and the host device 2 will be described in detail with reference to FIGS. 4 to 6.

FIG. 4 is an explanatory diagram of an operation sequence, which shows each example of normal data write operations in the memory card 1 and the host device 2. This FIG. 4 shows the respective operation sequences in the case of writing, into the memory card 1, the write data which is divided into the data D1 and D2 and is transferred, and data D3 that is new write data different from the above write data.

Shown in FIG. 4 are, from left to right, respective sequence operations of the host device 2, the memory controller 4, and the nonvolatile semiconductor memory 3, and is, from upper to lower, a time course. Further, a right side of the nonvolatile semiconductor memory 3 shows images of blocks (erased blocks B, and written (to-be-a-write-object) block A) in a memory array of the nonvolatile semiconductor memory 3.

First, the host device 2 issues a write command including data transfer information, and transfers the write command and the data D1 to the memory controller 4 (sequences Se10 and Se11). The data transfer information is composed of setting information such as transfer start addresses and transfer volumes.

In response to this, the memory controller 4 writes the data D1 into the erased block B (sequence Se12). When the write operation of the data D1 is finished, the memory controller 4 outputs, to the host device 2, an end command indicating that the write processing is finished (sequence Se13).

Subsequently, the host device 2 issues, to the memory controller 4, a write command including the data transfer information (sequence Se14). The memory controller 4 judges, from the data transfer information, whether the head address of the data D2 is continued to the last address of the data D1 (sequence Se15).

When judging that the addresses are continuous, the memory controller 4 writes continuously the data D2 (sequence Se16) transferred to the block B into which the data D1 is written (sequence Se17).

The memory controller 4 outputs an end command to the host device 2 after end of the data write of the data D2 (sequence Se18). In response to the end command, the host device 2 issues, to the memory controller 4, a write command including the data transfer information (sequence Se19).

The memory controller 4 judges, from its data transfer information, whether the head address of the data D3 is continued to the last address of the data D2 (sequence Se20). As mentioned above, the data D3 is new data different from the data D1 and D2.

Therefore, the addresses are not continuous, so that the memory controller 4 starts the copy processing (sequence Se21). In this copy processing, copied into the block B is original data of the block A written from a next address of the last address of the data D2 to a preceding address of the head address into which the data D3 is written.

When the copy processing is finished (sequence Se22), the host device 2 transfers the data D3 to the memory controller 4 (sequence Se23). The memory controller 4 writes the data D3 into the block B (sequence Se24), and outputs the end command to the host device 2 when the write operation is finished (sequence Se25).

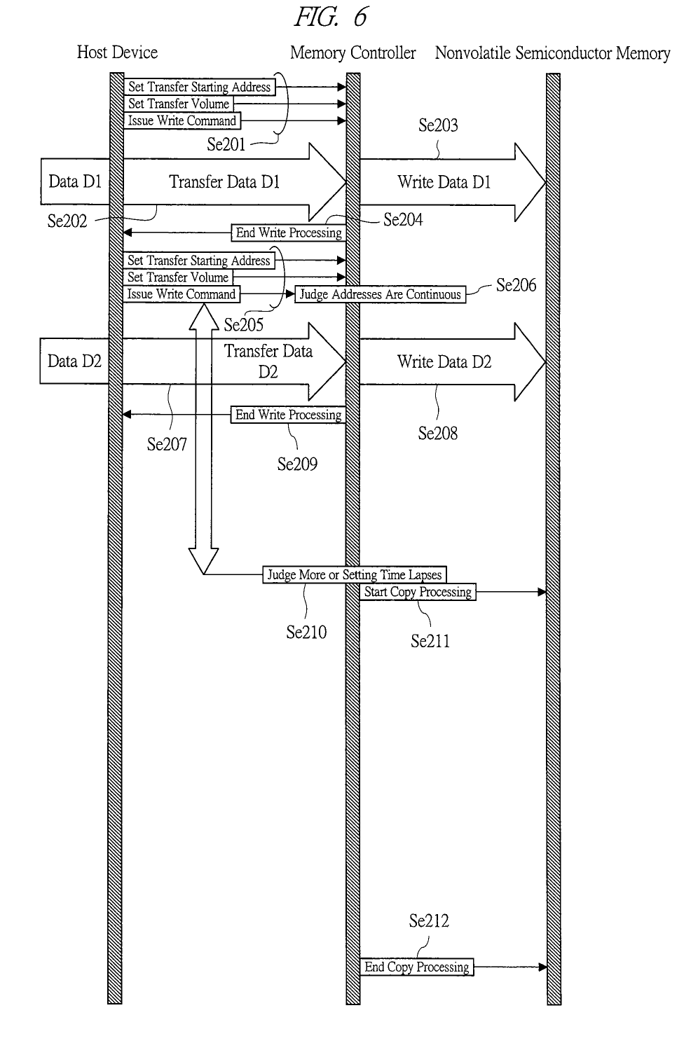

FIG. 5 shows an operation sequence in the case of: writing the write data which is divided into the data D1 and D2 and is transferred; thereafter issuing a read command from the host device 2; and reading out the data D3.

Shown also in this FIG. 5 are, from left to right, respective sequence operations of the host device 2, the memory controller 4, and the nonvolatile semiconductor memory 3, and is, from upper to lower, a time course.

First, the host device 2 issues a write command including the data transfer information, and transfers the write command and the data D1 to the memory controller 4 (sequences Se101 and Se102).

In response to this, the memory controller 4 writes the data D1 into the erased block (sequence Se103). Thereafter, the memory controller 4 outputs, to the host device 2, an end command indicating that the write processing is finished (sequence Se104).

Subsequently, the host device 2 issues, to the memory controller 4, the write command including the data transfer information (sequence Se105). The memory controller 4 judges, from the data transfer information, whether the head address of the data D2 is continued to the last address of the data D1 (sequence Se106).

When the addresses are continuous, the memory controller writes continuously the transferred data D2 (sequence Se107) into the block into which the data D1 is written (sequence Se108). The memory controller 4 outputs the end command to the host device 2 after end of the write operation of the data D2 (sequence Se109).

Next, on receiving the end command, the host device 2 issues, to the memory controller 4, a read command including the data transfer information (sequence Se110). When the memory controller 4 judges that the received command is not a write command (sequence Se111), it starts the copy processing (sequence Se112).

And, when the copy processing is finished (sequence Se113), the memory controller 4 reads out the data D3 from the nonvolatile semiconductor memory 3 based upon the data transfer information (sequence Se114), and transfers the read data D3 to the host device 2 (sequence Se115).

FIG. 6 shows operation sequences in the case of: writing the write data which is divided into the data D1 and D2 and is transferred; and then getting no response from the host device 2 even after an interval of time lapses.

Shown also in this FIG. 6 are, from left to right, respective sequence operations of the host device 2, the memory controller 4, and the nonvolatile semiconductor memory 3, and is, from upper to lower, a time course.

First, the host device 2 issues a write command including the data transfer information, and transfers the write command and the data D1 to the memory controller 4 (sequences Se201 and Se202).

In response to this, the memory controller 4 writes the data D1 into the erased block (sequence Se203). Thereafter, the memory controller 4 outputs, to the host device 2, an end command indicating that the write processing is finished (sequence Se204).

Subsequently, the host device 2 issues, to the memory controller 4, a write command including the data transfer information (sequence Se205). The memory controller 4 judges, from the data transfer information, whether the head address of the data D2 is continued to the last address of the data D1 (sequence Se206).

When the addresses are continuous, the memory controller 4 writes continuously the transferred data D2 into the block B into which the data D1 is written (sequence Se208). The memory controller 4 outputs an end command to the host device 2 after end of the write operation of the data D2 (sequence Se209).

Thereafter, when there is not any access from the host device 2 to the memory card 1 in a predetermined period (sequence Se210), the memory controller 4 starts the copy processing (sequence Se211). The copy processing is finished (sequence Se212).

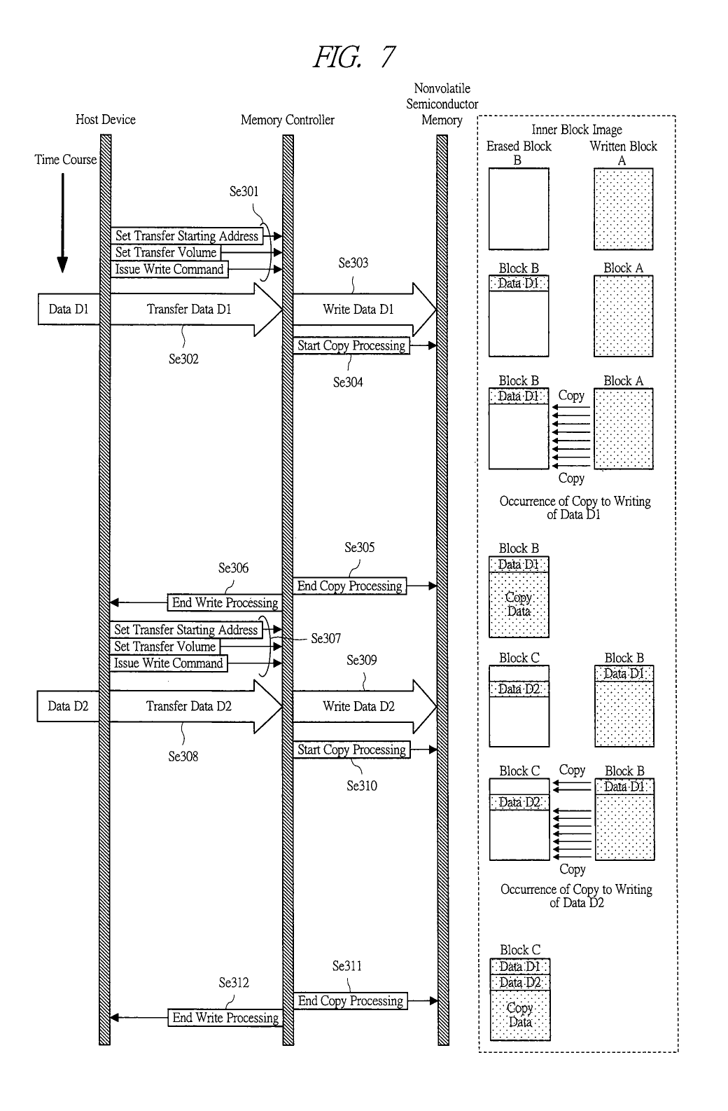

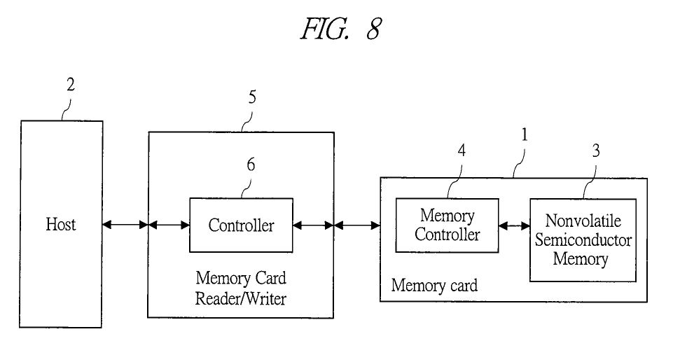

FIG. 7 is an explanatory diagram of an operation sequence showing an example of a data write operation of the memory card in which the copy processing is performed per data write by the write command considered by the present inventors.

Shown also in FIG. 7 are, from left to right, respective sequence operations of the host device, the memory controller, and the nonvolatile semiconductor memory, and is, from upper to lower, a time course. Further, a right side of the nonvolatile semiconductor memory shows images of blocks (erased blocks B and written (to-be-a-write-object) blocks A) in the memory array of the nonvolatile semiconductor memory.

First, the host device issues a write command including the data transfer information, and transfers the write command and the data D1 to the memory controller (sequences Se301 and Se302).

In response to this, the memory controller writes the data D1 into the erased block B (sequence Se303). When the write operation of the data D1 is finished, the memory controller copies, to the block B, the original data of the block A which has been written from a next address of the last address of the data D1 to the last address of the block B (sequence Se304). During a period of time of this copy processing, the host device cannot access the memory card.

When the copy processing is finished (sequence S305), the memory controller outputs an end command to the host device (sequence Se306). In response to this, the host device transfers, to the memory controller, the write command including the data transfer information and the data D (sequence Se307 and Se308).

The memory controller writes the data D2 transferred to a new erased block C from the data transfer information (sequence Se309), and starts the copy processing in the block C after end of the write operation of the data D2 (sequence Se310). In this copy processing, the original data of the block B except the data D2 is copied to the block C.

When the copy processing is finished (sequence Se311), the memory controller outputs the end command to the host device (sequence Se312), whereby the write operation is finished.

Thus, if the continuous write operation of the present invention is not carried out, the one-time copy processing occurs by performing the one-time write operation by the write command. For example, when the size of one block is 128 KB and the host writes the 2-kB data by the one-time write command, a copy processing of 126 kB (128 kB-2 kB) that is a difference of the data write occurs.

When the host device divides continuous 128-kB data per 2-kB data and issues the 64-times write commands to write the data, the copy processings of 126 kB×64 times=8064 kB will be performed, which results in the write processing time becoming very long.

Meanwhile, in the memory card 1 that performs the continuous write processing shown in the present embodiment, even in the case of dividing the continuous 128-kB data per 2-kB data and performing the data write, it is possible to make the above-mentioned copy processing of 8064 kB unnecessary.

Thereby, according to the present embodiment, it is possible to reduce drastically the data write time of the memory card 1, and improve the performance of the memory card 1.

As described above, the inventions made by the present inventors have been described concretely based upon the embodiments. However, needless to say, the present invention is not limited to the above-mentioned embodiments, and may be variously modified within a scope of not departing from the gist thereof.

For example, the above-mentioned embodiment adopts a configuration in which the memory card 1 is connected to the host device 2 (FIG. 1), but may has, as shown in FIG. 8, a configuration in which the host device 2 and the memory card 1 are connected via a memory card reader/writer 5 that controls the read and write of the memory card 1.

In this case, the controller 6 provided to the memory card reader/writer 5 controls the continuous write operation. Thereby, it is possible to reduce drastically the data write time of the memory card 1.

### INDUSTRIAL APPLICABILITY

The present invention is suitable for shortening of the data write time of the memory card.

1-8. (canceled)

9. A memory card connected to a host device in use, the memory card comprising:
an nonvolatile semiconductor memory having a plurality of nonvolatile memory cells and being capable of storing information therein; and
a memory controller instructing an operation of storing, in a second memory area of the nonvolatile semiconductor memory based on a command issued from the host device, data relating to data stored in a first memory area of the nonvolatile semiconductor memory,
wherein the host device divides, into arbitrary size, data to be transferred to the memory card, and is configured so as to transfer each of the divided data to the memory card by executing a procedure which includes, regarding each of the arbitrarily divided data, a step of issuing, to the memory controller, a write command including setting information for setting a data transfer starting address and a transfer data volume and a step of transferring, to the memory card, data to be written correspondingly to the write command subsequently to the step of issuing the write command, and
the memory controller judges, in a write processing of the data divided into arbitrary size by the host device, whether a last address of a previous data transfer and a head address of a next data transfer are continuous;
performs, if the addresses are continuous, the write processing of the data in the next data transfer subsequently to the data that has been written and processed in the previous data transfer; and executes, if the addresses are not continuous, a processing command for copying, into the second memory area, the data stored in the first memory area of the nonvolatile semiconductor memory.

10. The memory card according to claim 9,
wherein the memory controller performs the copy processing after the write processing of the data is finished when a command other than the write command is issued from the host device.

11. The memory card according to claim 9, wherein
the memory controller performs the copy processing when the write processing of the data is finished after any period of time lapses from issue of the write command by the host device.

12. A method of writing data into a nonvolatile semiconductor memory based upon a command issued from a host device in a memory card comprising the nonvolatile semiconductor memory having a plurality of nonvolatile memory cells and being capable of storing information, and a memory controller instructing an operation of the nonvolatile semiconductor memory,
wherein the host device divides, into arbitrary size, data to be transferred to the memory card, and is configured so as to transfer, to the memory card, each of the divided data by executing a procedure which includes, regarding each of the arbitrarily divided data, a step of issuing, to the memory controller, a write command including setting information for setting a data transfer starting address and a transfer data volume, and a step of transferring, to the memory card, data to be written correspondingly to the write command subsequently to the step of issuing the write command, and
the memory controller executes, regarding the data transferred from the host device and divided into arbitrary size, the stages of judging whether a last address of the data received by a previous data transfer and a head address of the data received by a next data transfer are continuous; performing, when it is judged that the addresses are continuous, the write processing of the data in the next data transfer subsequently to the data that has been written and processed in the previous data transfer; and executing, when it is judged that the addresses are not continuous, a proceeding command for copying, into the second memory area, the data stored in the first memory area of the nonvolatile semiconductor memory.

13. The method of writing data according to claim 11,
wherein the copy processing is carried out after the write processing of the data is finished when a command other than the write command is issued from the host device.

14. The memory card according to claim 11,
wherein the copy processing is carried out after the write processing of the data is finished when a period of time lapses from issue of the write command by the host device.

15. A method of writing data into a nonvolatile semiconductor memory based on a command issued from a host device in a memory card comprising the nonvolatile semiconductor memory and a memory controller instructing an operation of the nonvolatile semiconductor memory,
wherein the host device executes the stages of:
(a) dividing, into arbitrary side, data corresponding to the data stored in a first memory area of the nonvolatile semiconductor memory; and
(b) transferring each of the divided data to the memory card by executing a procedure which includes, regarding each of the data divided into arbitrary size, a step of issuing, to the memory controller, a write command containing setting information for setting a data transfer data stating address and a transfer data volume, and a step of transferring, to the memory card, the data to be written correspondingly to the write command subsequently to the step of issuing the write command, and
the memory controller executes, in the memory card, the stages of:
(c) writing, into a second block of the nonvolatile semiconductor memory, the arbitrarily-sized data transferred from the host device;
(d) judging whether a last address of the arbitrarily-sized data received by a previous data transfer and a head address of the arbitrarily-sized data received by a next data transfer are continuous;
(e) when the addresses are continuous in the stage (d), writing, into the second block, the data in the next data transfer subsequently to the data written and processed in the previous data transfer; and
(f) executing, when the addresses are not continuous in the stage (d), a processing command to copy, into the second block, the data stored in the first memory area of the nonvolatile semiconductor memory.
